(19) United States
(12) Patent Application Publication
(10) Pub. No.: US 2023/0068203 A1
(43) Pub. Date: Mar. 2, 2023

(54) CAREER PROGRESSION PLANNING TOOL USING A TRAINED MACHINE LEARNING MODEL

(71) Applicant: Oracle International Corporation, Redwood Shores, CA (US)

(72) Inventor: Siu Wan Surlina Yin, London (GB)

(73) Assignee: Oracle International Corporation, Redwood Shores, CA (US)

(21) Appl. No.: 17/673,382

(22) Filed: Feb. 16, 2022

Related U.S. Application Data
(60) Provisional application No. 63/240,076, filed on Sep. 2, 2021.

(51) Int. Cl. G06Q 10/06; G06N 3/08

(52) U.S. Cl. CPC G06Q 10/06398; G06N 3/08

(57) ABSTRACT

Techniques are disclosed for using a trained machine learning model to generate a career progression pathways that are evaluated in view of employment conditions and compromises (trade-offs) that are acceptable to an employee. The system trains the machine learning model using employee profiles. The employee profiles include employment histories, skills, credentials, and professional activities. Once trained, the system applies the machine learning model to an employee's profile to generate ML-based career progression paths for reach a target employment goal. Each ML-based career progression path defines one or more interim objectives for reaching the target employment goal. The system compares the interim objectives, as defined by the ML-based career progression paths, with new employment conditions that are acceptable to an employee. The system recommends a subset of the ML-based career progression path(s) with interim objectives that are compatible with the acceptable employment conditions.

### TECHNICAL FIELD

The present disclosure relates to employee success at work. In particular, the present disclosure relates to a career progression planning tool that uses a trained machine learning model.

### BACKGROUND

Career progression planning for employees in many types of organizations, particularly large organizations, can be complicated and obscure. In many cases it is difficult for an employee to know how to accomplish career goals. Requirements for target career objectives may not be evident based on a simple job requisition posting. Also, at times, consistent and accurate guidance tailored for individual employees for accomplishing a particular career goal is often not readily available. Typically, career progression advice is provided by a mentor who, while usually more senior to the protege being mentored, still is limited to the mentor's own direct experience with (and unconscious biases around) career progression. This experience may or may not be helpful to the protege.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for generating a career goal progression pathway that takes into account changes that an employee is willing to undertake to accomplish a career goal in accordance with one or more embodiments;

FIG. 3 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. SYSTEM ARCHITECTURE
3. GENERATING ML-BASED EMPLOYEE PROGRESSION PATH BASED ON EMPLOYEE INPUTS
4. COMPUTER NETWORKS AND CLOUD NETWORKS
5. MISCELLANEOUS; EXTENSIONS
6. HARDWARE OVERVIEW

1. General Overview

One or more embodiments use a trained machine learning (ML) model to generate career progression pathways for an employee. The system recommends a subset of the career progression pathways that are compatible with changes in employment conditions that are acceptable to the employee.

The system trains the machine learning model using employee profiles. The employee profiles include employment histories, skills, credentials, and professional activities. The employee profile may also include personal/professional activities, personal metrics, personality traits. In some examples, aspects of the employee profile may be inferred by a trained ML model (e.g., via “adaptive intelligence”). Once trained, the system applies the machine learning model to an employee's profile to generate ML-based career progression paths for reaching a target employment goal. In some examples, the system may graphically render or depict a particular goal and the one or more ML-based career progression paths to the particular goal. Each ML-based career progression path defines one or more interim objectives for reaching the target employment goal. The system compares the interim objectives, as defined by the ML-based career progression paths, with new employment conditions that are acceptable to an employee. The system recommends a subset of the ML-based career progression path(s) with interim objectives that are compatible with the employment conditions acceptable to the employee.

One or more embodiments described in this Specification and/or recited in the claims may not be included in this General Overview section.

2. System Architecture

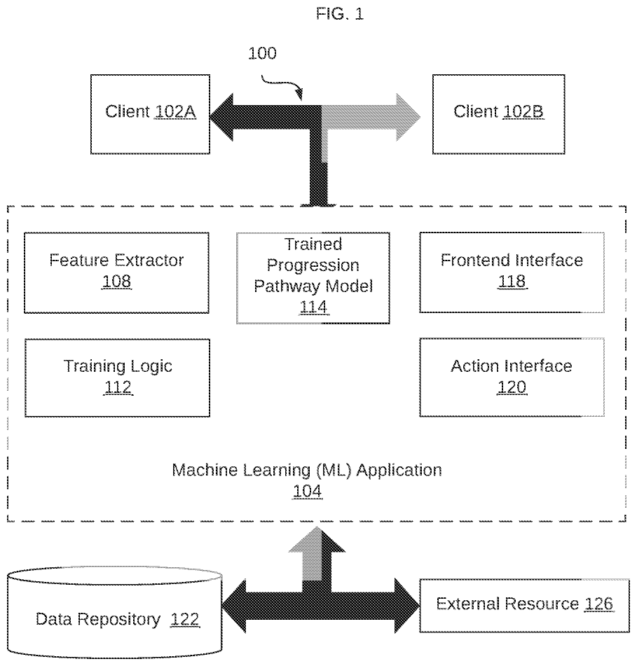

FIG. 1 illustrates a system 100 in accordance with one or more embodiments. As illustrated in FIG. 1, system 100 includes clients 102A, 102B, a machine learning application 104, a data repository 122, and an external resource 126. In one or more embodiments, the system 100 may include more or fewer components than the components illustrated in FIG. 1.

The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The clients 102A, 102B may be a web browser, a mobile application, or other software application communicatively coupled to a network (e.g., via a computing device). The clients 102A, 102B may interact with other elements of the system 100 directly or via cloud services using one or more communication protocols, such as HTTP and/or other communication protocols of the Internet Protocol (IP) suite.

In some examples, one or more of the clients 102A, 102B are configured to receive and/or generate data items that are stored in the data repository 122. These data items may include employee profiles, job requirements, organizational charts, and vector representations thereof.

The clients 102A, 102B may transmit the data items to the ML application 104 for analysis. The ML application 104 may analyze the transmitted data items by applying one or more trained ML models to the transmitted data items, thereby generating an employee progression path based on employee skills, preferred employee employment conditions, time frames, target employment goal requirements, and employee profile data corresponding to other employees.

The clients 102A, 102B may also include a user device configured to render a graphic user interface (GUI) generated by the ML application 104. The GUI may present an interface by which a user triggers execution of computing transactions, thereby generating and/or analyzing data items. In some examples, the GUI may include features that enable a user to view training data, classify training data, instruct the ML application 104 to generate an employee progression path that is based on employee preferences, and other features of embodiments described herein. As indicated above, each employee progression path may be based on (at least in part) the personal, and highly variably preferences of each corresponding employee. In some examples, the GUI may provide user interface elements (e.g., sliders, dials) so that the user may provide a ranking or greater weight to emphasize more important preferences and/or a less weight to less important preferences. The system may analyze these provided weights. Furthermore, the clients 102A, 102B may be configured to enable a user to provide user feedback via a GUI regarding the accuracy of the ML application 104 analysis. That is, a user may label, using a GUI, an analysis generated by the ML application 104 as accurate or not accurate, thereby further revising or validating training data. This latter feature enables a user to label data analyzed by the ML application 104 so that the ML application 104 may update its training.

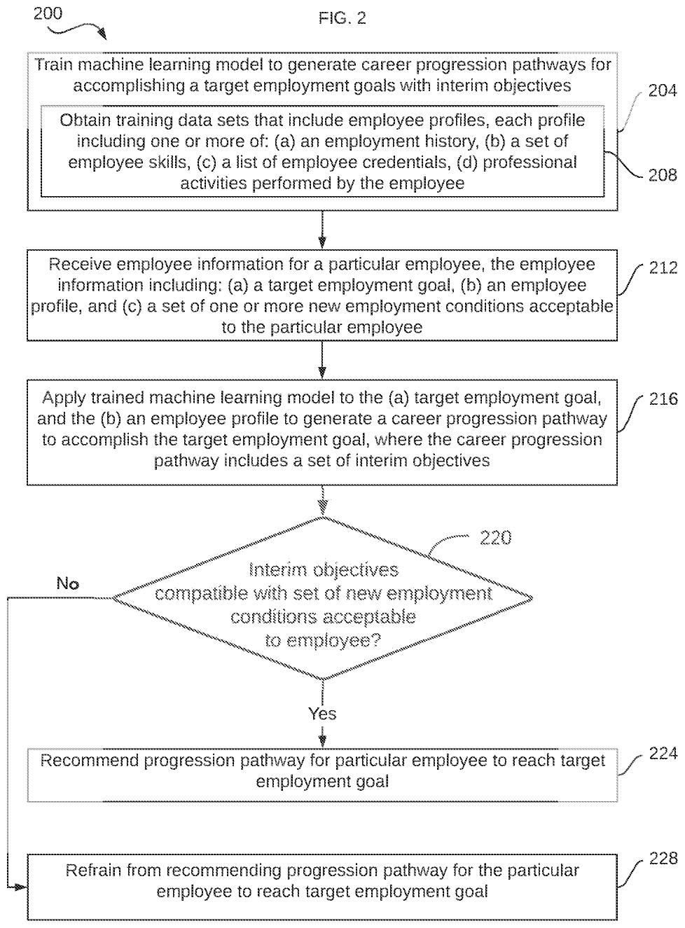

The ML application 104 of the system 100 may be configured to train one or more ML models using training data, prepare target data before ML analysis, and analyze data so as to generate an ML-based employee progression path (or paths) as described below in the context of FIG. 2.

The machine learning application 104 includes a feature extractor 108, training logic 112, a trained progression pathway model 114, a frontend interface 118, and an action interface 120.

The feature extractor 108 may be configured to identify characteristics associated with data items. The feature extractor 108 may generate corresponding feature vectors that represent the identified characteristics. For example, the feature extractor 108 may identify attributes within training data and/or “target” data that a trained ML model is directed to analyze. Once identified, the feature extractor 108 may extract characteristics from one or both of training data and target data.

The feature extractor 108 may tokenize some data item characteristics into tokens. The feature extractor 108 may then generate feature vectors that include a sequence of values, with each value representing a different characteristic token. In some examples, the feature extractor 108 may use a document-to-vector (colloquially described as “doc-to-vec”) model to tokenize characteristics (e.g., as extracted from human readable text) and generate feature vectors corresponding to one or both of training data and target data. The example of the doc-to-vec model is provided for illustration purposes only. Other types of models may be used for tokenizing characteristics.

In other examples, the feature extractor 108 may identify attributes associated with employee profiles and generate one or more feature vectors that correspond to the employee profiles. For example, the feature extractor 108 may identify employee skills, employee credentials, and/or employee professional activities within a set of employee profiles used as training data. The feature extractor 108 may also identify various features within employment histories of training employee profiles. These employment history features may include, for example, years of service, prior job titles and job responsibilities, position (individual contributor, department manager, functional manager, division vice president), years of service, and the like. In some examples the feature extractor 108 may also be applied to target data, such as information provided by an employee seeking a progression pathway to a target employment goal. In this situation, the system may analyze the feature vector generated by the feature extractor 108 to represent the target data using a trained ML model. In any of these situations, feature extractor 108 may then process the identified features and/or attributes to generate one or more feature vectors.

The feature extractor 108 may append other features to the generated feature vectors. In one example, a feature vector may be represented as [f₁, f₂, f₃, f₄], where f₁, f₂, f₃ correspond to characteristic tokens and where f₄ is a non-characteristic feature. Example non-characteristic features may include, but are not limited to, a label quantifying a weight (or weights) to assign to one or more characteristics of a set of characteristics described by a feature vector. In some examples, a label may indicate one or more classifications associated with corresponding characteristics.

As described above, the system may use labeled data for training, re-training, and applying its analysis to new (target) data. The feature extractor 108 may optionally be applied to new data (yet to be analyzed) to generate feature vectors from the new data. These new data feature vectors may facilitate analysis of the new data by one or more ML models, as described below.

The machine learning application 104 also includes training logic 112 and a trained progression pathway ML model 114.

In some examples, the training logic 112 receives a set of data items as input (i.e., a training corpus or training data set). Examples of data items include, but are not limited to, employee profiles. These profiles may include one or more of an employment history, a set of employee skills, a list of employee credentials, and professional activities for one or more employees. In some examples, employee profiles used for training (and/or in the analytical operations described below) may include personal metrics, lifelong achievements/accomplishments, personality traits, extracurricular activities besides skills recognized or identified by the organization, qualifications, talent ratings, and honors and awards that may or may not be already stored in a human resources employee database. In some cases, the training data may also include job titles, job requirements, certification and/or training program descriptions, and the like. The system may access training data from any of a variety of one or more sources. For example, the system may access training data stored within a human resources management system specific to the employer of the employee. In other examples, the system may access training data (e.g., external training) stored by a third-party system and that is publicly available, such as a social network (e.g., Facebook (R), Linkedln (R)). The data items used for training may also be associated with one or more attributes, such as those described above in the context of the feature extractor 108.

In some examples, training data used by the training logic 112 to train the machine learning engine 110 includes feature vectors of data items that are generated by the feature extractor 108, described above.

The training logic 112 may be in communication with a user system, such as clients 102A, 102B. The clients 102A,102B may include an interface used by a user to apply labels to the electronically stored training data set.

The trained progression pathway model 114 may include one or more machine learning models that may be trained using the training data acquired and/or prepared by the training logic 112. Once trained, the trained progression pathway model 114 may be applied to employee information provided by a particular employee to generate a career progression pathway.

In some examples, the trained progression pathway model 114 may include one or both of supervised machine learning algorithms and unsupervised machine learning algorithms. In some examples, the trained progression pathway model 114 may be embodied as any one or more of linear regression, logistic regression, linear discriminant analysis, classification and regression trees, naïve Bayes, k-nearest neighbors, learning vector quantization, support vector machine, bagging and random forest, boosting, back propagation, and/or clustering model. The trained progression pathway model 114 may be adapted to perform the techniques described herein, and in particular the operations described in the context of FIG. 2.

In some examples, multiple trained ML models of the same or different types may be arranged in a ML “pipeline” so that the output of a prior model is processed by the operations of a subsequent model. In various examples, these different types of machine learning algorithms may be arranged serially (e.g., one model further processing an output of a preceding model), in parallel (e.g., two or more different models further processing an output of a preceding model), or both.

The trained progression pathway model 114 may access information provided by a particular employee and analyze it to generate a career progression pathway for the particular employee. For example, the particular employee may submit (e.g., via a user interface facilitated by the frontend interface 118 and/or the action interface 120) employee information to be analyzed by the trained progression pathway model 114. The submitted information may include a target employment goal for the particular employee, an employee profile corresponding to the particular employee, and a set of one or more new employment conditions acceptable to the particular employee.

The trained progression pathway model 114 may use the information submitted by the particular employee to generate one or more ML-based career progression pathways. The trained progression pathway model 114, by executing the method 200 described below, executes a comparative analysis of the various options identified based on the training, the options' associated costs (e.g., time in role, higher academic degree, reduced salary, grade demotion), in light of the preferences provided by the employee. The trained progression pathway model 114 may recommend or otherwise highlight a subset of generated career progression pathways that include interim objectives that are compatible with and/or similar to the set of new employment conditions acceptable to the particular employee.

Other configurations of the ML application 104 may include additional elements or fewer elements.

The frontend interface 118 manages interactions between the clients 102A, 102B and the ML application 104. In one or more embodiments, frontend interface 118 refers to hardware and/or software configured to facilitate communications between a user and the clients 102A,102B and/or the machine learning application 104. In some embodiments, frontend interface 118 is a presentation tier in a multitier application. Frontend interface 118 may process requests received from clients and translate results from other application tiers into a format that may be understood or processed by the clients.

For example, one or both of the client 102A, 102B may submit requests to the ML application 104 via the frontend interface 118 to perform various functions, such as for labeling training data and/or analyzing target data. In some examples, one or both of the clients 102A, 102B may submit requests to the ML application 104 via the frontend interface 118 to generate and view a graphic user interface related to an ML-based employee progression path. In still further examples, the frontend interface 118 may receive user input that re-orders individual interface elements.

Frontend interface 118 refers to hardware and/or software that may be configured to render user interface elements and receive input via user interface elements. For example, frontend interface 118 may generate webpages and/or other graphical user interface (GUI) objects. Client applications, such as web browsers, may access and render interactive displays in accordance with protocols of the internet protocol (IP) suite. Additionally or alternatively, frontend interface 118 may provide other types of user interfaces comprising hardware and/or software configured to facilitate communications between a user and the application. Example interfaces include, but are not limited to, GUIs, web interfaces, command line interfaces (CLIs), haptic interfaces, and voice command interfaces. Example user interface elements include, but are not limited to, checkboxes, radio buttons, dropdown lists, list boxes, buttons, toggles, text fields, date and time selectors, command lines, sliders, pages, and forms.

In an embodiment, different components of the frontend interface 118 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, the frontend interface 118 is specified in one or more other languages, such as Java, C, or C++.

The action interface 120 may include an API, CLI, or other interfaces for invoking functions to execute actions. One or more of these functions may be provided through cloud services or other applications, which may be external to the machine learning application 104. For example, one or more components of machine learning application 104 may invoke an API to access information stored in a data repository (e.g., data repository 122) for use as a training corpus for the machine learning application 104. It will be appreciated that the actions that are performed may vary from implementation to implementation.

In some embodiments, the machine learning application 104 may access external resources 126, such as cloud services. Example cloud services may include, but are not limited to, social media platforms, email services, short messaging services, enterprise management systems, and other cloud applications. Action interface 120 may serve as an API endpoint for invoking a cloud service. For example, action interface 120 may generate outbound requests that conform to protocols ingestible by external resources.

Additional embodiments and/or examples relating to computer networks are described below in Section 4, titled “Computer Networks and Cloud Networks.”

Action interface 120 may process and translate inbound requests to allow for further processing by other components of the machine learning application 104. The action interface 120 may store, negotiate, and/or otherwise manage authentication information for accessing external resources. Example authentication information may include, but is not limited to, digital certificates, cryptographic keys, usernames, and passwords. Action interface 120 may include authentication information in the requests to invoke functions provided through external resources.

In one or more embodiments, data repository 122 may be any type of storage unit and/or device (e.g., a file system, database, collection of tables, or any other storage mechanism) for storing data. Further, data repository 122 may each include multiple different storage units and/or devices. The multiple different storage units and/or devices may or may not be of the same type or located at the same physical site. Further, data repository 122 may be implemented or may execute on the same computing system as the ML application 104. Alternatively or additionally, data repository 122 may be implemented or executed on a computing system separate from the ML application 104. Data repository 122 may be communicatively coupled to the ML application 104 via a direct connection or via a network.

Information related to target data items and the training data may be implemented across any of components within the system 100. However, this information may be stored in the data repository 122 for purposes of clarity and explanation.

In an embodiment, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

3. Generating ML-Based Employee Progression Path Based on Employee Inputs

FIG. 2 illustrates an example set of operations, referred to collectively as a method 200, for generating a career goal progression pathway that takes into account acceptable (to the employee) changes in the employment conditions to accomplish a career goal in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

The method 204 begins by training a machine learning model to generate ML-based career progression pathways (operation 204). As explained above, a career progression pathway may include one or more interim objectives that may be helpful, or in some cases required, in accomplishing a target employment goal or otherwise providing a path for an employee to progress according to the individual (potential) interests and preferences of each employee.

For example, a target employment goal involves laterally moving from one department having a set of responsibilities to a different department having a different set of responsibilities that are more aligned with the (potential) interests of a particular employee. Accomplishing this move to a different department may involve interim objectives such as acquiring different training, maintaining at least a minimum productivity level or performance rating, and/or successfully performing job duties in a third department as a way of acquiring insights and expertise useful in the target department.

In another example, a target employment goal may include a vertical change, such as a promotion. Similar to the example presented above, interim objectives for being promoted may include completing one or more projects of successively increasing complexity and/or responsibility, generating a sustained increase of work output and/or work quality as indicated in a performance review, acquiring additional training, demonstrating a capability to lead projects and/or manage budgets, and the like. In some embodiments, the analysis by the system of interim objectives may be described as using a “critical path” method of analysis, in paths consist of one or more necessary steps for accomplishing a goal. In some case, the system may develop multiple different critical paths for accomplishing a same goal via different career progression pathways.

In some examples, the training data may include sets of employee profiles that may be used to train the ML model to identify patterns in training data (e.g., employee profiles, work histories) that can lead to accomplishing any one or more target employment goals (operation 208). For example, a training data set may include many employee profiles. Each of the employee profiles may include one or more of an employment history, a set of employee skills, a list of employee credentials, and/or professional activities performed by the employee. In other examples, each employee profile may include personal metrics, lifelong achievements and accomplishments, personality traits, extracurricular activities, among other features. As indicated above, these training data may exist in the records of a particular organization and/or may be accessed via a third party data store, whether an industry database or a third-party data source (e.g., a social network).

The system may train the ML model with these data to identify career progression pathways for accomplishing the most recent and/or current employment position of each employee corresponding to each employee profile. The system may use these data to identify ML-based career progression pathways followed by the employees represented in the training data. For example, a division vice president may have progressively risen through many interim positions enroute to the current position of vice president. The system may analyze each of these positions, which were interim objectives to the vice president position, as though they were separate target employment goals. In this way, the system may analyze pathways that led to one or more interim positions held by an employee on the way to the current or final position held by the employee as training data to generate ML-based career progression pathways.

The system may receive employee information for a particular employee as a preliminary step to providing the particular employee with an ML-based career progression pathway to a target employment goal (operation 212). For example, the system may receive from the particular employee (a) a target employment goal, (b) an employee profile, and (c) a set of one or more new employment conditions that are acceptable to the employee as a means for accomplishing the target employment goal.

The target employment goal may be any of a number of possible work situations. As mentioned above, examples of target employment goals include, but are not limited to, a promotion (a higher “vertical” location in an organizational hierarchy), a change in geographic work location, a change in organization (e.g., division, department), a change in work content (e.g., from engineering to finance), a change in scope of responsibility (e.g., individual contributor to team leader), a change in work hours, compensation profile, and the like. In some examples, a target employment goal may include a position that is laterally equivalent to a current position held by an employee but with different functional responsibilities. This lateral target goal may be an interim goal (e.g., a transitional state) used to acquire credentials or experience needed for an ultimate target employment goal. Similarly, in other examples a target employment goal may include assuming a position that is at a lower position within the hierarchy of an organization that, based on ML analysis described herein, actually provides an efficient, direct, or effective route to a different target employment goal.

The employee profile submitted by the particular employee is analogous to the employee profiles described above in the context of the training data in the operation 208. That is, the employee profile for the particular employee may include credentials, education history, work history, performance ratings, compensation history, bonus history, certifications, current and prior work assignments, experience, position titles, and the like.

The set of one or more new employment conditions that are acceptable to the employee as a means for accomplishing the target employment goal identify the changes to work conditions that an employee is willing and/or able to contribute for accomplishing a target employment goal. For example, an employee may be willing to add skills by taking a lateral position in another department or a position with different job responsibilities. In another example, an employee may be willing to expand the employee's professional network by taking an assignment at a different geographic location and/or different sub-unit of a company (e.g., corporate headquarters). The employee may be willing to acquire post-graduate degrees, additional certifications, and the like.

Regardless of the contribution, the employee may indicate these preferences and provide them to the system as part of the operation 212.

The system may apply the trained ML model to generate one or more ML-based career progression pathways, which includes a set of interim objectives (operation 216). A career progression pathway may be based on (a) the target employment goal and the (b) employee profile. As indicated above, the trained ML model may execute the operation 216 using any number of different ML models, whether clustering, similarity analysis, neural network analysis, among others. The trained ML model generate a career progression pathway for an employee based training data for employees with similar backgrounds, similar employment trajectories inside the same organization as the employee, and/or with regard to training data from sources external to the organization that employs the employee (e.g., outside the company and/or outside an employing organization (e.g., division, department) within the company). In some examples, the system may generate a career progression pathway based on weights to some preference provided by the user for the preferring change in working conditions. In some examples, the user may even provide (or the system may determine) preferences in terms of tradeoffs, such as time to accomplish a goal vs. compensation, annual worked hour/pathway effort vs. time needed to accomplish a goal, or other similar tradeoff situations. In other situations, the trained ML model may render its career progression pathway analysis without this level of user preference/tradeoff. In this regard, the employee may indicate a set of compromises between (i.e., tradeoffs) between competing preferences and/or constraints. In a generate sense, the tradeoff represented in the employee preferences may be indicated (or represent) a compromise between a preferred new employment condition and additional resource consumption associated with the employee. In one illustration, this tradeoff may be a preferred new working condition of a change in work location that involves the additional employee resource consumption of longer work hours, the expense of moving a home location, added commute time, delayed promotion/raise increase schedule.

In some examples, the system may also include in the ML-based career progression pathways an analysis of needs of a particular organization. For example, a system may be provided with a list of critical skills, certifications, or experience that an organization believes are valuable, in demand, or otherwise needed, but lacking, within the organization. The system may identify whether any of the employment conditions that are acceptable to the employee are similar to or otherwise match the skills desired by the organization.

In the event that there is overlap between the employment conditions acceptable to the employee and the interests of the organization, the system may emphasize the one or more ML-based career progression pathways that contain this overlap in interests between the employee and the organization. In one illustration, the system may provide a notice indicating the accelerated career progression prospects that arise from pursuing a career progression pathway that would cause the employee to develop a skill that is deficient in the organization. In some examples, a skill deficiency may be associated with skills, job duties, or other aspects of the target position for the employee.

Once the system generates ML-based career progression pathways and associated interim objectives, the system may determine whether the interim objectives of the pathways are compatible with the new employment conditions that are acceptable to the employee (operation 220). The system may also identify any interim objectives for the target employment goal that are already present in the profile associated with the target employee and thus already satisfy some of the interim objectives toward the goal.

The system may execute this analysis using any of one or more techniques. For example, the system may apply a trained neural network to vectorized forms of the employee information and apply one or more hidden layers to determine if the employee information is compatible with any one or more of the career progression pathways.

In another example, the system may apply other types of trained machine learning models to execute the operation 220. For example, the system may execute a similarity analysis (e.g., cosine) that: (1) determines which interim objectives have already been completed by the employee; and (2) for any interim objectives not already completed by the employee, compares vector representations of the remaining interim objectives of the career progression pathways to vector representations of the new employment conditions acceptable to the employee. If the comparison generates a similarity value above a threshold value (e.g., above 0.5, above 0.75), then the system may determine that the compared interim objectives are compatible with the acceptable new employment conditions.

In some examples, the system may train and use a natural language processing model to analyze natural language in job descriptions, employee records, or other data used by the system. Once the natural language data has been processed (e.g., represented as a vector), other ML models described above may be applied to the vector to generate a progression pathway. The system may train an NLP model using, for example a publicly available natural language processing (NLP) dataset. Examples of publicly available NLP datasets include, but are not limited to, those available from commoncrawl (commoncrawl.org) and Wikipedia®.

The system may access industry-specific NLP training datasets. Examples include, but are not limited to those available from Luminati, University of California Irvine, and Kaggle. The system may also access pre-trained NLP models that include, but are not limited to, Google® BERT, Microsoft® CodeBERT®, among others.

Regardless of the machine learning analysis technique applied, the system, in the operation 220, determines whether any interim objectives for one or more ML-based career progression pathways that are missing from the employee profile are similar to new employment conditions that the employee is willing to pursue.

In some cases, the system may apply additional filters and/or criteria to assure that the interim objectives of the career progression pathways are in fact compatible with the new employment conditions acceptable to the employee. For example, in some examples the preceding similarity analysis may be executed on vector representations of the interim objectives and the new employment conditions as a whole. This collective analysis may, however, fail to detect incompatible pathway in which, for example, a particular new employment condition that is highly similar (e.g., cosine similarity above 0.9) to a corresponding interim objective overwhelms the signal from another interim objective in the pathway that is not an acceptable new employment condition. To prevent this type of misanalysis, the system may execute a preliminary similarity analysis that compares individual interim objectives to individual new employment conditions. The system may then identify whether each interim objective has a corresponding acceptable new employment condition that is at least a threshold similarity value. Once this filter has been applied, the system may execute the analysis described above.

If interim objectives within the career progression pathways generated in the operation 216 are compatible with the new employment conditions acceptable to the employee, then the system may recommend some or all of the generated progression pathways to the user (operation 224). In some examples, the system may recommend one or more of the pathways by presenting, in a graphical user interface, a list of the interim objectives. In examples in which multiple pathways are recommended, the system may organize the recommended career progression pathways under individual headings and list corresponding interim objectives in association with (e.g., below) each heading. In other situations, the system may present a summary or title of the recommended pathways. Additional details associated with each pathway, such as the interim objectives, may be viewable upon user selection (e.g., clicking, opening, or other engagement).

However, if the interim objectives within an ML-based career progression pathway generated in the operation 216 are not compatible with the new employment conditions acceptable to the employee, then the system may refrain from recommending a particular progression pathway to the employee (operation 228).

4. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

5. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

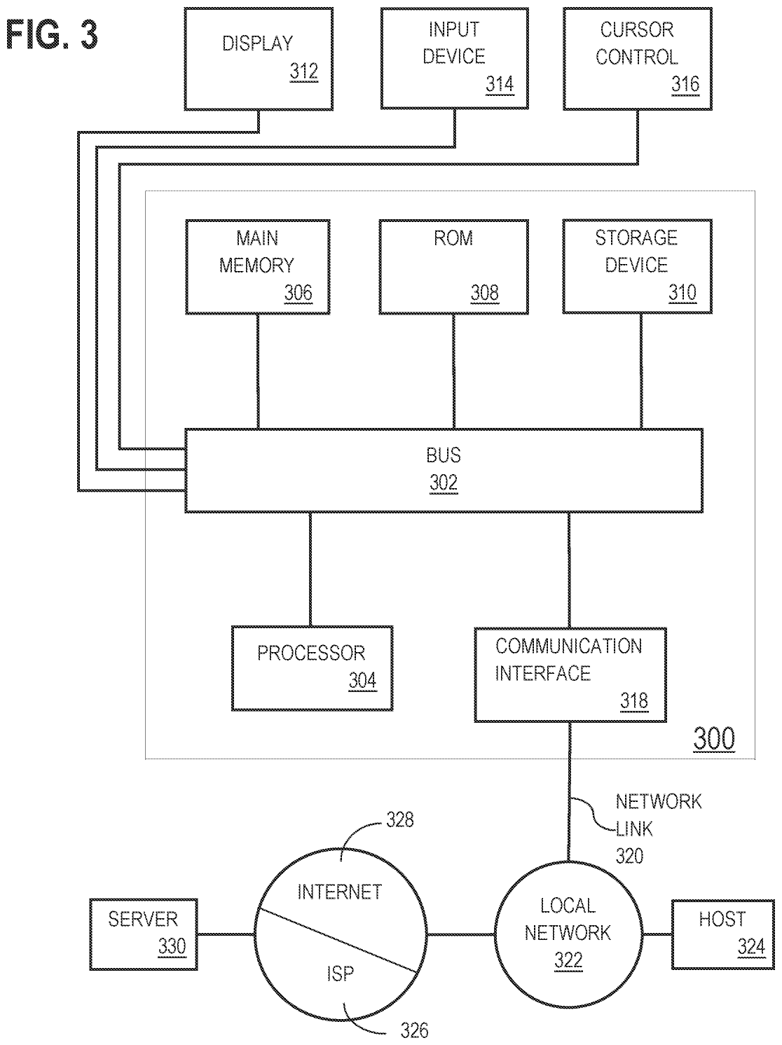

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing instructions, which when executed by one or more hardware processors, cause performance of operations comprising:
training a machine learning model to generate career progression pathways for accomplishing target employment goals, each of the career progression pathways comprising a corresponding set of one or more interim objectives, the training including at least:
obtaining training data sets, each training data set comprising:
a plurality of employee profiles comprising one or more of an employment history, a set of employee skills, a list of employee credentials, and professional activities performed by employees corresponding to the plurality of employee profiles;
training the machine learning model based on the training data sets;
receiving, for a particular employee, employee information comprising:
a target employment goal for the particular employee;
an employee profile corresponding to the particular employee;
a set of one or more new employment conditions acceptable to the particular employee;
applying the trained machine learning model to the employee profile corresponding to the particular employee and the target employment goal to generate a first ML-based career progression pathway to accomplish the target employment goal, the first ML-based career progression pathway comprising a first set of one or more interim objectives that the particular employee must meet to reach the target employment goal;
determining that the first set of one or more interim objectives is compatible with the set of new employment conditions acceptable to the particular employee; and
responsive to determining that the first set of one or more interim objectives is compatible with the set of new employment conditions acceptable to the particular employee: recommending the first ML-based career progression pathway for the particular employee to reach the target employment goal.

2. The media of claim 1, wherein the operations further comprise:
applying the trained machine learning model to the employee profile corresponding to the particular employee and the target employment goal to generate a second ML-based career progression pathway to accomplish the target employment goal, the second ML-based career progression pathway comprising a second set of one or more interim objectives that the particular employee must meet to reach the target employment goal;
determining that the second set of one or more interim objectives is not compatible with the set of new employment conditions acceptable to the particular employee; and
responsive to determining that the second set of one or more interim objectives is not compatible with the set of new employment conditions acceptable to the particular employee: refraining from recommending the second ML-based career progression pathway for the particular employee to reach the target employment goal.

3. The media of claim 2, wherein the operations further comprise applying a second machine learning model to determine the set of one or more new employment conditions acceptable to the particular employee, wherein the second machine learning model is trained based on information associated with the employee.

4. The media of claim 1, wherein the operations further comprise:
identifying a set of requirements associated with the target employment goal;
identifying a subset of the set of requirements missing from the employee profile corresponding to the particular employee and also not represented in the first ML-based career progression pathway; and
adding the subset of requirements to the first ML-based career progression pathway.

5. The media of claim 1, wherein the at least one absent interim objective is selected based on a similarity score above a threshold value relative to the corresponding new employment conditions.

6. The media of claim 1, wherein the new employment condition comprises one or more of an additional certification, a change in compensation rate, a change in work location, a change in work schedule, and a change in work function.

7. The media of claim 1, wherein the operations further comprise:
identifying a set of skill deficiencies associated with an organization;
identifying an interest in at least one of the skill deficiencies in the set of the new employment conditions; and
promoting the first ML-based career progression pathway among a set of ML-based career progression pathways based on the first ML-based career progression pathway including an interim progression objective that corresponds to the at least one of the skill deficiencies.

8. The media of claim 1, wherein the trained machine learning model is a neural network.

9. The media of claim 1, wherein the trained machine learning model is a pipeline of a plurality of trained machine learning models comprising at least two of a clustering model and a neural network.

10. The media of claim 1, wherein the set of new employment conditions comprises at least one tradeoff between a first new employment condition and a corresponding first change in employee resource consumption.

11. The media of claim 1, wherein the operations further comprise:
applying the trained machine learning model to the employee profile corresponding to the particular employee and the target employment goal to generate a second ML-based career progression pathway to accomplish the target employment goal, the second ML-based career progression pathway comprising a second set of one or more interim objectives that the particular employee must meet to reach the target employment goal;
determining that the second set of one or more interim objectives is not compatible with the set of new employment conditions acceptable to the particular employee;
responsive to determining that the second set of one or more interim objectives is not compatible with the set of new employment conditions acceptable to the particular employee: refraining from recommending the second ML-based career progression pathway for the particular employee to reach the target employment goal;
applying a second machine learning model to determine the set of one or more new employment conditions acceptable to the particular employee, wherein the second machine learning model is trained based on information associated with the employee;
identifying a set of requirements associated with the target employment goal;
identifying a subset of the set of requirements missing from the employee profile corresponding to the particular employee and also not represented in the first ML-based career progression pathway;
adding the subset of requirements to the first ML-based career progression pathway;
identifying a set of skill deficiencies associated with an organization;
identifying an interest in at least one of the skill deficiencies in the set of the new employment conditions;
promoting the first ML-based career progression pathway among a set of ML-based career progression pathways based on the first ML-based career progression pathway including an interim progression objective that corresponds to the at least one of the skill deficiencies;
wherein the trained machine learning model is a neural network;
wherein the at least one absent interim objective is selected based on a similarity score above a threshold value relative to the corresponding new employment conditions; and
wherein the new employment condition comprises one or more of an additional certification, a change in compensation rate, a change in work location, a change in work schedule, and a change in work function.

12. A method comprising:
training a machine learning model to generate career progression pathways for accomplishing target employment goals, each of the career progression pathways comprising a corresponding set of one or more interim objectives, the training including at least:
obtaining training data sets, each training data set comprising:
a plurality of employee profiles comprising one or more of an employment history, a set of employee skills, a list of employee credentials, and professional activities performed by employees corresponding to the plurality of employee profiles;
training the machine learning model based on the training data sets;
receiving, for a particular employee, employee information comprising:
a target employment goal for the particular employee;
an employee profile corresponding to the particular employee;
a set of one or more new employment conditions acceptable to the particular employee;
applying the trained machine learning model to the employee profile corresponding to the particular employee and the target employment goal to generate a first ML-based career progression pathway to accomplish the target employment goal, the first ML-based career progression pathway comprising a first set of one or more interim objectives that the particular employee must meet to reach the target employment goal;
determining that the first set of one or more interim objectives is compatible with the set of new employment conditions acceptable to the particular employee; and
responsive to determining that the first set of one or more interim objectives is compatible with the set of new employment conditions acceptable to the particular employee: recommending the first ML-based career progression pathway for the particular employee to reach the target employment goal.

13. The method of claim 12, further comprising:
applying the trained machine learning model to the employee profile corresponding to the particular employee and the target employment goal to generate a second ML-based career progression pathway to accomplish the target employment goal, the second ML-based career progression pathway comprising a second set of one or more interim objectives that the particular employee must meet to reach the target employment goal;
determining that the second set of one or more interim objectives is not compatible with the set of new employment conditions acceptable to the particular employee; and
responsive to determining that the second set of one or more interim objectives is not compatible with the set of new employment conditions acceptable to the particular employee: refraining from recommending the second ML-based career progression pathway for the particular employee to reach the target employment goal.

14. The method of claim 12, further comprising:
identifying a set of requirements associated with the target employment goal;
identifying a subset of the set of requirements missing from the employee profile corresponding to the particular employee and also not represented in the first ML-based career progression pathway; and
adding the subset of requirements to the first ML-based career progression pathway.

15. The method of claim 12, wherein the at least one absent interim objective is selected based on a similarity score above a threshold value relative to the corresponding new employment conditions.

16. The method of claim 12, wherein the new employment condition comprises one or more of an additional certification, a change in compensation rate, a change in work location, a change in work schedule, and a change in work function.

17. The method of claim 12, further comprising:
identifying a set of skill deficiencies associated with an organization;
identifying an interest in at least one of the skill deficiencies in the set of the new employment conditions; and
promoting the first ML-based career progression pathway among a set of ML-based career progression pathways based on the first ML-based career progression pathway including an interim progression objective that corresponds to the at least one of the skill deficiencies.

18. The method of claim 12, wherein the set of new employment conditions comprises at least one tradeoff between a first new employment condition and a corresponding first change in employee resource consumption.

19. A system comprising:
at least one device including a hardware processor;
the system being configured to perform operations comprising:
training a machine learning model to generate career progression pathways for accomplishing target employment goals, each of the career progression pathways comprising a corresponding set of one or more interim objectives, the training including at least:
obtaining training data sets, each training data set comprising:
a plurality of employee profiles comprising one or more of an employment history, a set of employee skills, a list of employee credentials, and professional activities performed by employees corresponding to the plurality of employee profiles;
training the machine learning model based on the training data sets;
receiving, for a particular employee, employee information comprising:
a target employment goal for the particular employee;
an employee profile corresponding to the particular employee;
a set of one or more new employment conditions acceptable to the particular employee;
applying the trained machine learning model to the employee profile corresponding to the particular employee and the target employment goal to generate a first ML-based career progression pathway to accomplish the target employment goal, the first ML-based career progression pathway comprising a first set of one or more interim objectives that the particular employee must meet to reach the target employment goal;
determining that the first set of one or more interim objectives is compatible with the set of new employment conditions acceptable to the particular employee; and
responsive to determining that the first set of one or more interim objectives is compatible with the set of new employment conditions acceptable to the particular employee: recommending the first ML-based career progression pathway for the particular employee to reach the target employment goal.

20. The system of claim 19, further comprising:
applying the trained machine learning model to the employee profile corresponding to the particular employee and the target employment goal to generate a second ML-based career progression pathway to accomplish the target employment goal, the second ML-based career progression pathway comprising a second set of one or more interim objectives that the particular employee must meet to reach the target employment goal;
determining that the second set of one or more interim objectives is not compatible with the set of new employment conditions acceptable to the particular employee; and
responsive to determining that the second set of one or more interim objectives is not compatible with the set of new employment conditions acceptable to the particular employee: refraining from recommending the second ML-based career progression pathway for the particular employee to reach the target employment goal.

21. The system of claim 19, further comprising:
identifying a set of requirements associated with the target employment goal;
identifying a subset of the set of requirements missing from the employee profile corresponding to the particular employee and also not represented in the first ML-based career progression pathway; and
adding the subset of requirements to the first ML-based career progression pathway.

22. The system of claim 19, wherein the at least one absent interim objective is selected based on a similarity score above a threshold value relative to the corresponding new employment conditions.
